(19) United States
(12) Patent Application Publication
(10) Pub. No.: US 2025/0363232 A1
(43) Pub. Date: Nov. 27, 2025

(54) MANAGING FILE SYSTEM ACCESS POLICIES

(71) Applicant: Cristie Software Ltd, Stroud (GB)

(72) Inventors: James Reynolds, Stroud (GB); Ian Cameron, Stroud (GB); Jordan Stopford, Stroud (GB); Scott Sterry, Stroud (GB)

(21) Appl. No.: 19/216,952

(22) Filed: May 23, 2025

(30) Foreign Application Priority Data
May 23, 2024 (GB) 2407340.5

(51) Int. Cl. G06F 21/62; G06F 21/56; G06F 21/60

(52) U.S. Cl. CPC G06F 21/6218; G06F 21/56; G06F 21/602

(57) ABSTRACT

A method of protecting access to files on a computer file system is disclosed. A kernel-mode file system filter driver controls access to stored policies. Some access policies will cause the file system filter driver to send a request to a user-mode policy configuration service. The user-mode policy configuration service includes features allowing safe autoconfiguration of policies for new applications, and safe reconfiguration of policies for updated applications.

### CROSS REFERENCE TO RELATED APPLICATIONS

This application claims the benefit of priority to Great Britain patent application No. 2407340.5, filed on May 23, 2024; the entirety of which is hereby incorporated by reference herein.

### BACKGROUND OF THE INVENTION

### Field of the Invention

The present invention relates to managing file system access policies in a computer, and particularly to a file system blocker which can be used to protect against malicious software, especially ransomware.

### Background

Protecting the integrity of data held on computer systems is of great importance. In recent years, a type of malicious software known as ransomware has been used by criminals. Through some vulnerability, attackers are able to install ransomware on a target computer system. The ransomware will typically encrypt files so that they can no longer be accessed without a secret key, which is held by the criminals. The criminals will offer to reveal the secret key to decrypt the files, typically in exchange for payment in the form of cryptocurrency.

It is known to use access control policies to protect file systems from unauthorised modification, and this goes some way to protect against ransomware attacks. In principle policies can be configured so that only certain applications can access files. The files are thus protected from malicious software since a policy will not be in place to allow the unknown or malicious software to access the filesystem. However, this simple approach can in practice be circumvented by more sophisticated ransomware. One technique used by attackers is to replace an already trusted application with a malicious version. The replacement application will perform all of the required functions of the known application, and be indistinguishable in use from the genuine version. However, the malicious version in the background can use its trusted access to the filesystem to, for example, encrypt files for a ransomware attack.

File system access policies are complex, and in many scenarios, it is unrealistic to configure them manually. Automatic configuration is known, whereby a user can essentially trust an application to access whatever it is trying to access at the point of the request and then remember that setting in a stored policy. However, applications are often updated and their corresponding access policy may need to be updated also, in order for the application to continue to work. Frequent automatic or semi-automatic updating of access policies runs the risk that in practice the application's access is not controlled at all-anything the application tries to do will end up being allowed. Although the application may be in theory a trusted application, there is always a risk that it may have been maliciously modified.

It is an object of the present invention to reduce or substantially obviate the aforementioned problems.

### SUMMARY OF THE INVENTION

According to the present invention, there is provided a method of protecting resources on a computer file system, the method comprising:

providing a file system filter driver, the file system filter driver being configured to control access to resources in the file system by processes according to stored policies, each policy comprising a mapping of a process to a resource and an associated action, and each policy further including a process fingerprint, the process fingerprint being a hash of all executable code comprised in the process, the file system filter driver being configured to apply a policy to a running process only if the stored fingerprint in the policy matches a hash of all executable code comprised in the running process.

The file system filter driver will prevent access to resources, for example files and directories, except in accordance with policies. The policies associate particular allowed actions (for example, read, read/write, read/write with notify) with particular processes and particular resources. In other words, a policy is a tuple comprising (process, resource, allowed action(s)). The process is defined by, or additionally labelled with, a fingerprint. The fingerprint is a hash of all executable code comprised in the process. Therefore, if any executable file, DLL, or other component including executable code is changed, the process will no longer match the fingerprint and the policy will no longer apply.

A policy may be defined as applying to a specific resource (e.g. a single file) or a group of resources, for example all files in a directory, all files in a directory and all subdirectories, or even all files in the file system.

The executable code comprised in the process may include both compiled binaries and interpreted code. Some different examples of processes may include: an executable file combined with one or more DLLs (dynamic link libraries), and a generic interpreter combined with interpretable source code.

When a process is running, it may load more code dynamically. The code will need to be loaded from the file system, and so a suitable policy will need to be in place to allow access. Once the code has been loaded, the fingerprint of the process will change. Policies therefore need to be stored associated with the process both before and after new code has been dynamically loaded.

For example, a process may on first loading consist of the executable binary process.exe. During runtime, process.exe may load plugin1.dll, so that the running process now consists of both process.exe and plugin1.dll. There will be a policy associated with the process consisting of process.exe, with a fingerprint calculated from a hash of just process.exe, and there will be another policy associated with the process consisting of process.exe and plugin1.dll, with a fingerprint calculated from a combined hash of both process.exe and plugin1.dll. There will need to be a policy associated with process.exe which allows access to plugin1.dll, so that plugin1.dll can be loaded in the first place, but there may also be other policies allowing access to other resources, for example configuration files and data files.

The file system filter driver may be a kernel-mode driver.

Preferably, a user-mode policy configuration service is provided. A policy associated with a process and resource may have a “request” action. The “request” action does not directly allow or block access to the resource, but may allow access to the resource according to a judgment performed by the user-mode policy configuration service. The user-mode policy configuration service may make a judgment, as described in more detail below, and then update the relevant policy so that there is a static defined action (e.g. allow read/write) associated with that process and resource in the future.

Preferably, policies may be configured for an application as follows. First, an entry point executable is identified for the application. For example, the entry point executable may be a file called process.exe. A policy is then defined and stored by calculating the fingerprint of that entry point executable, and associating it with the “request” action for all resources, in our example as follows:
Process: process.exe
Process fingerprint: hash of process.exe
Resources: <all resources>
Action: request

The user-mode policy configuration service is then placed into a “learning” mode, and process.exe is executed. The process is executed and will start trying to access resources. For this process, all resources have been associated with the “request” action, and so any resource the process tries to access will result in a request being sent to the policy configuration service. When in “learning” mode, the policy configuration service responds to these requests by storing a policy allowing the requested action, and then making a determination as to whether the requested access is to further executable code. If the requested access is not to executable code, then the policy configuration service allows the action now, as mentioned already stores a policy allowing the action for the future, and does nothing further. However, if the requested access is executable code, the policy configuration service allows the action now, as mentioned already stores a policy allowing the action for the future, and then stores a new policy with a new process fingerprint. The new policy relates to the process comprising both the entry point executable, and the code which has been loaded. The new policy has the “request” action associated with all resources, so that the policy configuration service will continue to “learn” what policies are needed by the combined process. The previous policy which associated the “request” action with all resources for the entry point executable on its own is deleted.

In an illustrative example, the entry point executable is process.exe as before. The policy configuration service is put into “learning” mode, a policy is stored as below, and process.exe is executed.
Process: process.exe
Process fingerprint: hash of process.exe
Resources: <all resources>
Action: request

process.exe then tries to load plugin1.dll. The action associated with this, as defined by the policy, is “request”, and so the request is passed by the file system filter driver to the user-level policy configuration service. Because the policy configuration service is in “learning” mode, it allows the action, and stores a policy to allow the action in the future:
Process: process.exe
Process fingerprint: hash of process.exe
Resources: plugin1.dll
Action: allow read

The policy configuration service identifies that plugin1.dll is executable code. It

therefore also creates a new policy for the process consisting of both process.exe and plugin1.dll so that it can “learn” what policies are required for this process to access the resources it needs to work. The “request for all resources” policy associated with process.exe on its own is deleted:

Delete the following policy:
Process: process.exe
Process fingerprint: hash of process.exe
Resources: <all resources>
Action: request
   and create the following policy:
Process: process.exe, plugin1.dll
Process fingerprint: hash of (process.exe, plugin1.dll)
Resources: <all resources>
Action: request

The running process (comprising process.exe and plugin1.dll) then tries to load a file called config.txt. Because the relevant policy is set to “request” for all resources, the file system filter driver will pass the request to the user-level policy configuration service. Because the policy configuration service is in “learning” mode, it will allow the request and store a policy so that the request is always allowed in the future:
Process: process.exe, plugin1.dll
Process fingerprint: hash of (process.exe, plugin1.dll)
Resources: config.txt
Action: allow read

The policy configuration service will then identify that config.txt is not executable code. Therefore no further changes will be made at this time. The relevant policies associated with this application are at this point as follows:
Process: process.exe
Process fingerprint: hash of process.exe
Resources: plugin1.dll
Action: allow read
Process: process.exe, plugin1.dll
Process fingerprint: hash of (process.exe, plugin1.dll)
Resources: <all resources>
Action: request
Process: process.exe, plugin1.dll
Process fingerprint: hash of (process.exe, plugin1.dll)
Resources: config.txt
Action: allow read

The learning process can continue until the application has loaded all the resources (code or not) which it requires. It can be seen that this will result in the generation of policies allowing access to the required resources, and only the required resources. Furthermore, the policies are tied strictly to fingerprints which are associated with all the executable code, including for example DLLs and interpreted code which are comprised in the process at the time that access to the relevant resource is required. Any modification of any of the code, for example by a malicious actor, will result in access to the resources no longer being allowed.

Once the learning process is complete, the “request for all resources” policy is removed. The policy configuration service can also be taken out of “learning” mode, so that any “request” actions sent to the policy configuration service will in any case be denied.

It is envisaged that the learning process can be run in a controlled manner, for example when an application has been first installed from a trusted source. The learning process as described does not need to be and should not be repeated (including, as will be seen, if the application is updated). Any changes (for example, malicious changes caused by criminals trying to insert ransomware code) to executable code will result in the fingerprints in the policies no longer matching the running processes, and so access to resources by modified processes will be effectively prevented.

The learning process is preferably run on a computer system at a time before it is exposed to a risk, for example before it has been connected to the internet or before users are allowed to use the system. The risk of malicious software being present while the learning process is run is therefore significantly mitigated. The learning process allows for reliable automatic configuration of minimal policies so that the trusted application can access only the resources it requires, and only as long as the code of the trusted application remains unmodified.

A problem therefore arises when the application needs to be updated. The configured policies will no longer allow the application to function once the binaries have been changed, since the fingerprints in the stored policies will no longer match the hash of the process code at runtime. However, re-running the learning process to reconfigure the policies carries security risks, since by the time the application is updated, the computer may have been exposed to the internet, removable media, and other possible sources of malicious code. More generally, the computer will have been used by users and so the risk that malicious code is present on the computer (possibly lying dormant until the opportunity arises to obtain access to the filesystem) is increased. Re-running the learning process in these circumstances could give malicious code the file system access it needs to cause damage.

Preferably therefore, the user-mode policy configuration service can be operated in an “application upgrade” mode as follows. The “application upgrade” mode comprises two stages—firstly, an “upgrade installation” stage, and secondly, an “upgrade policy learning” stage.

In the upgrade installation stage, a trusted updater binary is provided, for example upgrade.exe. A policy is configured as follows, to allow the updater to run:
Process: upgrade.exe
Process fingerprint: hash of upgrade.exe
Resources: <all resources>
Action: upgrade

The “upgrade” action, like the “request” action, sends a request to the user-mode policy configuration service. The user-mode policy configuration service is able to distinguish “upgrade” requests and “request” requests and behave differently. In other words, both “request” and “upgrade” actions are types of “refer” action. The file system filter driver will handle all “refer” actions the same, by sending the request to the user mode policy configuration service for a determination. However, the user mode policy configuration service may handle “upgrade” actions differently from “request” actions.

In the upgrade installation stage, the updater binary (in this case upgrade.exe) is executed. Whenever the updater binary wants to access a resource, an “upgrade” request is sent to the user-mode policy configuration service, which is in “application upgrade” mode at the “upgrade installation” stage.

For example, the updater binary may want to write to file process.exe. Because of the policy associated with process upgrade.exe, the user-mode policy configuration service will process this request.

When receiving an “upgrade” request, the policy configuration service will try to match the resource being accessed with any currently stored policies. Particularly, it will try to match the resource being accessed with any of the process fields of the current policies. In this example, the updater binary is requesting to write to process.exe, which is the subject of current policies created in the “learning mode” described above. The policies which involve process.exe are updated by recalculating the associated fingerprints:
Process: process.exe
Process fingerprint: recalculated hash of process.exe
Resources: plugin1.dll
Action: allow read
Process: process.exe, plugin1.dll
Process fingerprint: recalculated hash of (process.exe, plugin1.dll)
Resources: config.txt
Action: allow read

In trying to match resources being accessed to existing fingerprints, heuristics may be employed to allow some inexact matching where it is likely to be a new version of the same process. It is typical for upgrades to construct a new directory with new files and then swap the directories over to complete the upgrade. This means that it may not be as simple as just matching the resource being accessed/overwritten to an existing policy—a heuristic might need to be used to recognise that a new file being written is a replacement version of an existing process and therefore the policy should be updated.

Where the resource being accessed is not matched to a process which is the subject of an existing policy (which could be because the resource is a configuration or data file), the policy configuration service will try to determine whether the access of the resource is an operation internal to the upgrade process (in which case the operation needs to be allowed but no new policy needs to be created, since the upgrade process will only happen once), or whether it is an operation external to the upgrade process (e.g. the intended result of the upgrade process is to create new files which can in due course be accessed by the application being upgraded). In the second case, the operation is allowed and relevant policies are identified and extended. The policies are extended by adding a policy with the relevant process and resource and the “request” action. For example, if an upgrade process creates a new directory then the policy configuration service extends the relevant policies to include a “request” action in relation to that directory.

Note that to identify the relevant policies, the policy configuration service needs to identify relevant processes which may need to access the new directory. Again, heuristics can be used to find existing policies which relate to processes in similar directories.

Once the “upgrade installation” stage is complete, the upgrade process will have installed all the relevant files and resources in exactly the same way that the upgrade process would run without the file system filter driver being present at all. Policies have been updated by the policy configuration service, but these new policies are not complete in that they include policies with the “request” action. When the policy configuration service is not in “learning” or “upgrade” mode, “request” actions will be denied.

Clearly, the policy configuration service could be put into “learning” mode again to configure the policies to allow everything which the new version of the application needs to do. However, this would result in the policy configuration being increasingly expanded to allow applications to do whatever they want, with no real scrutiny. This is risky, and if it is done often, for frequent upgrades, on computers which are uncontrolled in the sense that they may be connected to the internet, be used with removable media, or have generally been used by users, then it may undermine the point of using a file system filter driver to restrict and control access to the file system in the first place.

The preferred next step therefore is to run the upgraded application for the first time, but with the user-mode policy configuration service set in the “upgrade policy learning” stage rather than in the “learning mode” which was used when the application was first installed. The “upgrade policy learning” mode, rather than simply setting up policies to allow all actions, tests the application and makes judgments about new policies based on whether the access required has a purpose in relation to the function of the application. This results in tighter control of new policies, and reduces the risk that malicious software will be able to hijack the upgrade process to gain access to resources which should be protected.

When the upgraded application is first run, some of its actions will be expressly allowed by the updated policies. These actions are allowed by the filter driver and requests do not need to be passed to the policy configuration service. However, some of its actions will match policies with the “request” action. In the “upgrade policy learning” stage, the policy configuration service deals with these requests as follows. The first time such a request is made, the policy configuration service blocks the request.

The effects of blocking the request may then be observed. One way of doing this is to examine a log file associated with the application. The policy configuration service can use the log file to determine whether the application has logged an error which is linked to the blocked request. If so, a policy allowing requests to the resource may be created. If not, a policy blocking requests to the resource is created (or alternatively, no policy is created, since the default behaviour of the filter driver may be to block requests which do not match a policy).

More generally, the effect of the blocked request is observed, whether through the log file or otherwise. By observing the effects of blocking the request, the policy configuration service is essentially attempting to discover the purpose of the request and make a judgment as to whether that purpose is likely to be legitimate in the context of what the application is supposed to be doing. A trained machine learning model may be used in some embodiments to decide whether to allow or block such requests based on observed behaviour.

In one embodiment, the first time such a request is made, the policy configuration service blocks the request and increments a counter. This behaviour continues until the counter is above a limit (which might be, for example, 1 or 2 blocked requests). Once the counter is above the limit, indicating that repeated requests have been made to the resource, the policy configuration service examines a log file associated with the application, or otherwise attempts to determine the purpose of the request and the effect of blocking the request. The policy configuration service may for example examine the log file to determine whether the application has logged an error which is linked to the blocked request(s). If so, a policy allowing requests to the resource is created. If not, a policy expressly blocking requests to the resource is created (or alternatively, no policy is created, since the default behaviour of the filter driver may be to block requests which do not match a policy).

By blocking requests until they have been made repeatedly and a counter has been incremented above a threshold, a more minimal working policy can be configured for an application. Applications have resources which they absolutely must be able to access, or they will fail. But many applications also try to access resources which are not really essential to their operation. Where policies are configured to allow these non-essential accesses the potential attack surface is unnecessarily increased.

Often, the application will deal with a failure to access such a resource by re-attempting access a certain number of times before giving up. By insisting on repeated requests before the policy configuration service will consider the request in light of the observed effects of blocking it, many non-essential permissions are kept out of policies.

In order to determine whether an error in the log file is linked to a blocked request, a machine learning algorithm may be used to compare log portions to detect anomalies. The applicant's granted patent GB2589628 describes suitable techniques for doing this, in the context of recovery of backups.

Once the upgraded application has run for a period of time, the policy can be finalised. I.e. all “request” policies can be removed. The policy configuration service is taken out of upgrade mode and so in any case any requests sent to the policy configuration service will be denied.

In some embodiments, the set of policies may be compressed, for example to determine whether a set of policies relating to different resources can be replaced with a single policy relating to the set of resources—e.g. if there are individual policies allowing access to files a, b, c and d, and a, b, c and d are the only four files in a particular directory, and no other process is allowed access to that directory, then the four individual policies may be replaced by a single policy allowing access to the directory as a whole.

Heuristics may be used to determine whether filenames which are the subject of policies are fixed or dynamic. Example heuristics are:
filenames are logged and appear differently in multiple log templates
filenames contain date/time stamps
filenames contain counters

Where dynamic filenames are identified, it may be necessary to extend policies to give access to whole directories, or to ranges of filenames, rather than limit them to particular filenames.

The process of the invention allows automatic configuration of policies, while reducing risk associated with just allowing a policy configuration service to set up policies to allow access to all resources an upgraded process is trying to access. In particular the upgrade mode allows applications to be upgraded reliably, while ensuring the file system access policies remain closely controlled to prevent malicious damage to resources.

### BRIEF DESCRIPTION OF SEVERAL VIEWS OF THE DRAWINGS

For a better understanding of the present invention, and to show more clearly how it may be carried into effect, reference will now be made by way of example only to the accompanying drawings, in which:

FIG. 1 is a flowchart showing an initialisation process when configuring a policy for an application for the first time;

FIG. 2 is a flowchart showing actions of the user-mode policy configuration service in learning mode;

FIG. 3 is an example set of policies configured by the user-mode policy configuration service when taking the actions shown in FIG. 2;

FIG. 4 is a flowchart showing an initialisation process when preparing to update an application; and

FIG. 5 is a flowchart showing actions of the user-mode policy configuration service in the upgrade installation stage;

FIG. 6 is an example set of policies being configured by the user-mode policy configuration service when taking the actions shown in FIG. 5; and

FIG. 7 is a flowchart showing actions of the user-mode policy configuration service in the upgrade policy learning stage.

### DETAILED DESCRIPTION OF THE ILLUSTRATED EMBODIMENTS

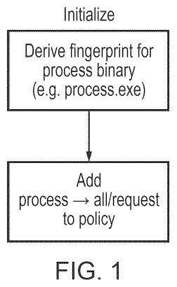

Referring firstly to FIG. 1, a new application has been installed. To initialise the application so that a policy can be learned, firstly a primary entry point binary is identified. In this example the entry point binary is called process.exe. A fingerprint is calculated by hashing the code comprised in process.exe and a policy is stored as follows: Action: Process: process.exe Action: Process fingerprint: hash of process.exe Action: Resources: <all resources>Action: Action: request

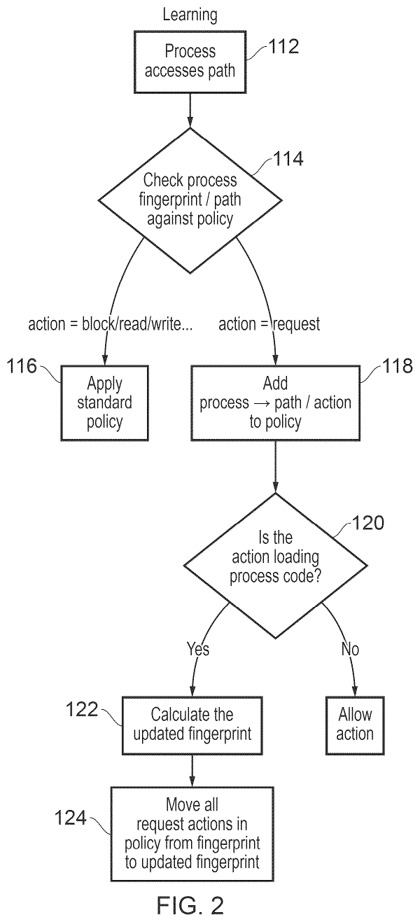

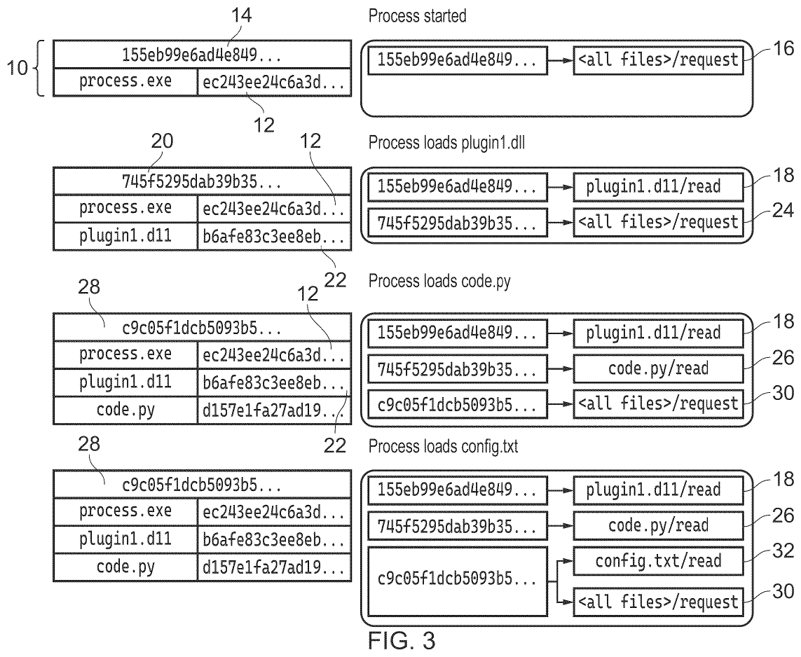

The user-mode policy configuration service is then put into learning mode, and follows the flow shown in FIG. 2. FIG. 3 shows how the process of FIG. 2 stores policies in an example.

In FIG. 3, example process fingerprints are shown on the left-hand side. During initialisation (according to the FIG. 1 flow), a process fingerprint 10 is calculated for the entry point binary process.exe. In more detail, a hash 12 is calculated of process.exe and stored. The process fingerprint value 14 is then calculated by taking a hash of a combination of all the hashes of individual files, which in this case is just the one.

The policies are shown on the right-hand side of FIG. 3. The policy associated with process.exe on its own is indicated at 16. The fingerprint 14 associated with process.exe is associated with <all files> as a resource, with “request” as the associated action.

After this initialisation process, the learning process (FIG. 2) begins. The binary process.exe is executed. As soon as it tries to access a resource [step 112 in FIG. 2] the file system filter driver deals with the request by checking [step 114] whether there is a matching policy. The file system filter driver will then handle the resource access request according to the policy. If there is a definite action (e.g. block, allow read, allow write) associated with the policy then the filter driver applies this [step 116]. However, in this example at this stage, the only policy associated with process.exe has a “request” action. This is passed to the user-mode policy configuration service by the file system filter driver which carries out the steps shown from 118 onwards in FIG. 2. Because the user-mode policy configuration service is in learning mode, it first adds a policy which allows the process to do whatever it is trying to do in relation to the resource [step 118]. In this example, process.exe tries to read plugin1.dll, and so a policy is added to allow this [18, FIG. 3].

Then, [step 120, FIG. 2] the policy configuration service determines whether the action (in our example, process.exe reading plugin1.dll) is loading process code. In this case, plugin1.dll does indeed contain process code and so an updated fingerprint is calculated [step 122] which encompasses all the process code in both process.exe and plugin1.dll. This new fingerprint is indicated at 20 in FIG. 3, and is calculated in this embodiment by hashing a combination of individual hashes 12, 22 associated with respectively process.exe and plugin1.dll. This approach, of calculating (and storing) individual hashes associated with each file, and then combining the hashes to create the fingerprints, improves performance when repeatedly calculating fingerprints.

The next step [124, FIG. 2] is to move all of the “request” actions which were associated with the previous fingerprint 14 to the new fingerprint 20. Or, to put it another way, a new policy 24 is created which associates the new fingerprint 20 with a “request” action for all resources, and the policy 16 which associated the fingerprint of just process.exe with all resources is deleted.

Next, the process tries to load code.py and the flow shown in FIG. 2 proceeds in exactly the same way. At step 112 the process (which includes code of both process.exe and plugin1.dll) tries to access code.py. At step 114 the file system filter driver checks the request against stored policies and identifies that the policy indicated at 24 in FIG. 3 matches. As a result the flow branches to step 118 and a new policy [26, FIG. 3] is added. At step 120 the policy configuration service identifies that code.py is process code (in this case, it is interpreted python code rather than a compiled binary, but this is treated in the same way for this purpose), and so in step 122 a new fingerprint 28 is calculated. Then, at step 124 previous policy 24 is removed and new policy 30 is added, so that “request” actions are associated with anything the process comprising all of process.exe, plugin1.dll and code.py may now try to do.

Next, back at step 112 the process tries to load config.txt. This action is checked against the policy store at step 114 by the filesystem filter driver. It matches policy 30 and the associated action is a “request” action, so the user-mode policy configuration service carries out the steps from 118. At step 118 new policy 32 is added to allow the process to read config.txt in the future. Step 120 determines that config.txt is not executable code, and so the action of reading config.txt is allowed and no further action is taken to update policies. Hence no new fingerprint is calculated, and policy 30 is not replaced by a new policy. The process can continue to run, and resource accesses will continue to be handled according to the FIG. 2 flowchart and policies updated by the policy configuration service, until the learning stage is completed.

The “request for all resources” policy 30 can be removed when the learning process is completed. In any case, once the policy configuration service is not in learning mode, it will not allow requests sent by the filesystem filter driver to the user-mode policy configuration service.

The installed application should now run successfully, with a minimal but working policy configuration in place to allow the application to function, but minimise risk by allowing access only to resources it needs, and only if recognised code is loaded. Attempts to insert malicious code into the application will result in process code no longer matching the stored fingerprints, and the filesystem filter driver will no longer allow those processes to access resources.

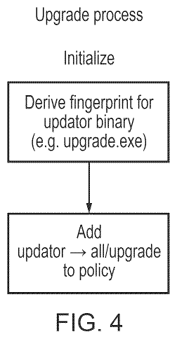

At some point, the application will need to be updated. An updater binary will be obtained from a trusted source. In this case, the updater binary is called upgrade.exe. To initialise the update process a policy is stored to associate upgrade.exe with the “upgrade” action for all resources, as shown in FIG. 4.

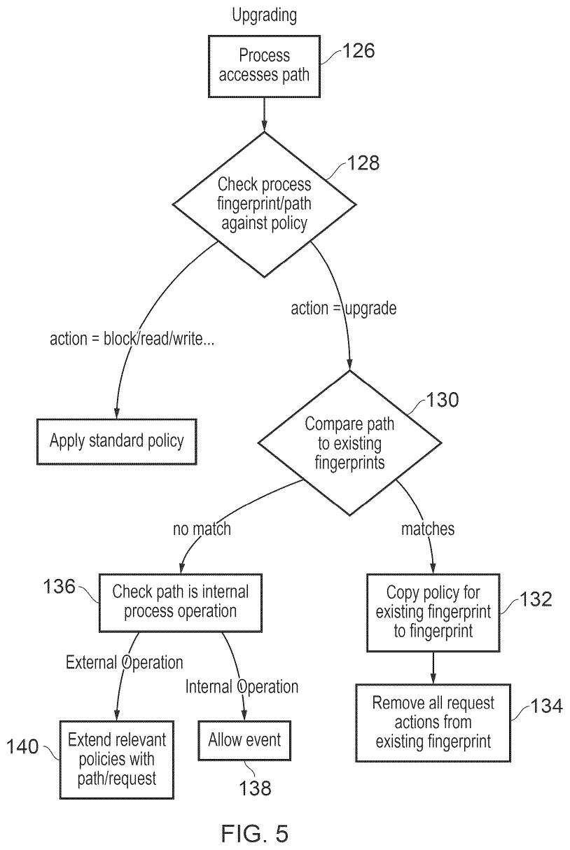

In FIG. 5, the updater binary is run, and the user-mode policy configuration service is put into upgrade mode, at an upgrade installation stage.

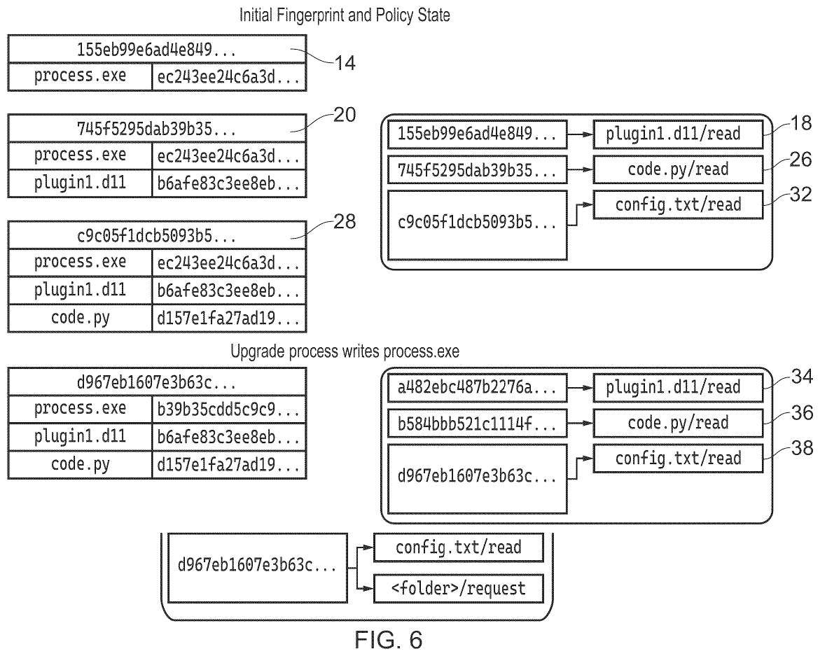

The updater binary at step 126 attempts to access a resource. In this case, the updater binary is attempting to write to process.exe, to install a new version. At step 128, the filesystem filter driver checks the write attempt against stored policies (as it always does). The only policy associated with the running process, upgrade.exe, has the “upgrade” action and so the request is passed to the user-mode policy configuration service. At step 130 the policy configuration service identifies whether there are stored policies which are going to be affected by the requested action. In other words, the policy configuration checks for policies which are fingerprinted to the old version of process.exe which is being replaced. In this case there are three such policies—18, 26 and 32 in FIG. 6. The fingerprints associated with these policies all need to be recalculated. Note that fingerprint 14 is associated with process.exe alone and needs to be recalculated but also fingerprint 20 which is associated with the combination of process.exe and plugin1.dll, and also fingerprint 28 which is associated with the combination of process.exe, plugin1.dll and code.py. The recalculated fingerprints are used to update policies 18, 26, 32 by creating new policies 34, 36, 38 with the newly-calculated fingerprints. Any “request” actions in the existing policies (there are none in the FIG. 6 example) are removed at step 134.

Next, the updater binary writes to <path> [step 126, FIG. 5]. The filesystem filter driver again handles this request [step 128], and because the policy matching the updater binary has the “upgrade” action set for all resources, the request is passed to the user-mode policy configuration service. At step 130 the policy configuration service attempts to match the access request to existing fingerprints, i.e. it tests to see whether files being modified are files which are fingerprinted and will need fingerprints updating as when process.exe was modified, discussed above. In this case, there is no match, and so the policy configuration service moves to step 136 where it determines whether the operation is internal to the updating process. If so, the event needs to be allowed but no policy changes need to be made [step 138]. Otherwise, at step 140 relevant policies are extended with the “request” action being associated with <path>. This means identifying processes relevant to the application being updated, and adding a “request” action associated with <path> to the policy store [new policy 40, FIG. 6].

The flow at FIG. 5 will be repeated until the update process is finished. Every time the update process attempts to access the filesystem, the flow at FIG. 5 runs and updates fingerprints or extends policies as required.

At the end of this process, policies will be in place for the updated application, but they will be incomplete as they contain “request” actions. “Request” actions, it will be recalled, are handled by the user-mode policy configuration service, and when the policy configuration service is not in learning mode these “request” actions will generally be denied. The updated application is therefore not likely to run correctly yet.

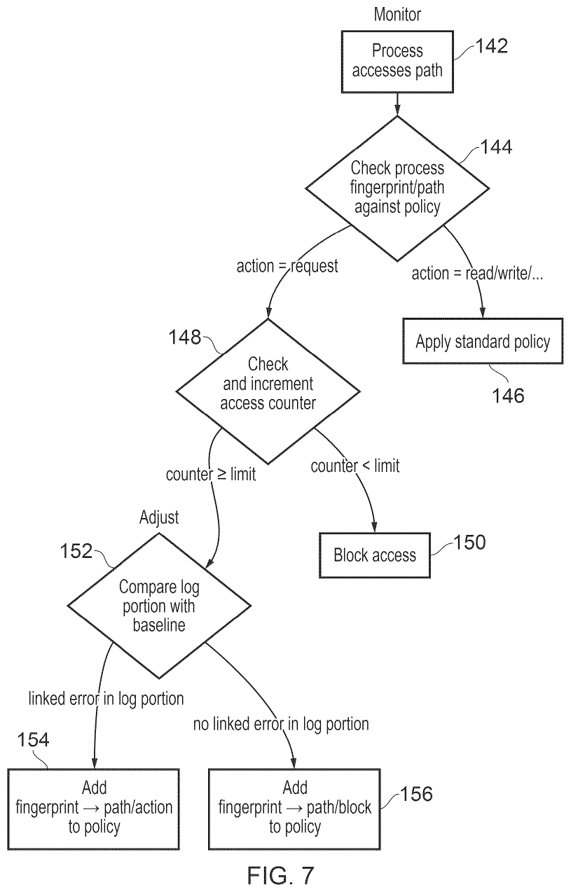

The next stage takes place with the user-mode policy configuration service in “upgrade policy learning” mode, and is illustrated in FIG. 7. The newly-upgraded application is run, in this example by executing process.exe. As before, the application will attempt to access a resource as it is running [step 142, FIG. 7]. The filesystem filter driver will deal with the access request by checking against stored policies in step 144. If a stored policy exists which is directly relevant to this access request (i.e. a matching process fingerprint and resource combination with a permission, for example, read or read/write), then the filesystem filter driver can directly deal with the request at step 146. However, if the matching process fingerprint and resource combination has a “request” action, then the request is sent to the user-mode policy configuration service, which is in an “upgrade policy learning” mode. At step 148 a counter associated with the access request is checked, the value tested against a threshold, and then incremented. If the counter value does not meet the threshold (which will always be the case for at least the first access attempt) then the resource access request is denied in step 150. This may be repeated a few times, depending on the level at which the threshold is set. Once the counter is checked and it is at or above the threshold, the flow moves to step 152. In this step, log files are inspected to determine whether an error exists which is associated with the current resource request being processed. The principle is that if the blocking of the previous requests was stopping the application from functioning correctly, this should manifest itself in the application log files. Hence automated inspection of the log files after requests have been blocked can determine whether the requested access is required for the application to function, in which case an appropriate policy is added at step 154 so that the updated application can correctly function, or whether the requested access has no clear purpose in relation to the functioning of the application, in which case it should be permanently blocked at step 156.

Hence the inventive system allows for self-configuring security policies to allow filesystem access only where it is required. It is resilient against malicious code being injected by adapting stored policies when an application is upgraded rather than by re-learning the policies from scratch.

The embodiments described above are provided by way of example only, and various changes and modifications will be apparent to persons skilled in the art without departing from the scope of the present invention as defined by the appended claims.

What is claimed is:

1. A method for protecting resources on a computer file system, the method comprising:
providing a file system filter driver, the file system filter driver being configured to control access to resources in the file system by processes according to stored policies, each policy comprising a mapping of a process to a resource and an associated action, and each policy further including a process fingerprint, the process fingerprint being a hash of all executable code comprised in the process, the file system filter driver being configured to apply a policy to a running process only if the stored fingerprint in the policy matches a hash of all the executable code comprised in the running process.

2. The method as claimed in claim 1, in which the file system filter driver is a kernel-mode driver.

3. The method as claimed in claim 1, further comprising:
providing a user-mode policy configuration service,
wherein the file system filter driver is adapted to control access to a resource by a process based on a determination made by the user-mode policy configuration service if a policy associated with said process and resource has an associated action indicating that the determination should be referred to the policy configuration service (a “refer” action).

4. The method as claimed in claim 3, comprising the step of configuring a policy for an application by:
identifying an entry point executable associated with the application;
defining and storing a policy for the entry point executable by calculating a fingerprint of the entry point executable and associating it with a “refer” action for all resources;
placing the user-mode policy configuration service into a learning mode; and
executing the entry point executable.

5. The method as claimed in claim 4, in which the user-mode policy configuration service, when in learning mode, responds to resource access requests by allowing the request and storing a policy allowing the request.

6. The method as claimed in claim 5, in which the policy configuration service, when in learning mode, responds to resource access requests by making a determination as to whether the resource being accessed is executable code, and if the resource being accessed is executable code, stores a new policy with a new process fingerprint, the new process fingerprint being associated with all executable code in the process making the resource access request, and also the executable code resource to which access is being requested.

7. The method as claimed in claim 3, comprising the step of updating an application and updating the policy associated with the application by:
identifying an entry point executable associated with the application update;
defining and storing a policy for the entry point executable associated with the application update by calculating a fingerprint of the entry point executable and associating it with a “refer” action for all resources;
placing the user-mode policy configuration service into an “upgrade installation” mode; and
executing the entry point executable associated with the application update.

8. The method as claimed in claim 7, in which the user-mode policy configuration service, when in upgrade installation mode, responds to resource access requests by:
checking stored policies to determine whether the resource being accessed matches a process for which a policy is stored; and
recalculating process fingerprint(s) associated with any such policies.

9. The method as claimed in claim 8, wherein the policy configuration service, in the case where no matching policies are identified, responds to a resource access request by extending one or more policies associated with the application being updated by adding a “refer” action in relation to the resource to which access is requested.

10. The method as claimed in claim 9, in which the step of updating an application and updating the policy associated with the application further includes:
placing the user-mode policy configuration service into an “upgrade policy learning” mode; and
executing the entry point executable associated with the application.

11. The method as claimed in claim 10, in which the user-mode policy configuration service in the “upgrade policy learning” mode responds to resource requests by:
blocking the request;
observing the effect of blocking the request on the running application; and
making a determination as to whether the request is an essential request in the context of the application and, if so, storing a policy allowing the request.

12. The method as claimed in claim 11, in which the effect of blocking the request is observed by examining log file(s) associated with the application.

13. The method as claimed in claim 12, in which log file(s) associated with the application are examined to determine whether an error in the log file(s) can be linked to the request and, if so, storing a policy allowing the request.

14. The method as claimed in claim 10, in which the user-mode policy configuration service in the “upgrade policy learning” mode responds to resource requests by:
checking and incrementing a counter associated with the request; and
if the counter was below a threshold, blocking the request;
if the counter was above the threshold, making a determination as to whether the request is an essential request in the context of the application and, if so, storing a policy allowing the request.

15. A computer program product comprising a file system filter driver and a user-mode policy configuration service, the computer program product when installed on a computer adapting the computer to carry out the method according to claim 1.
